(19) United States
(12) Patent Application Publication
(10) Pub. No.: US 2017/0226349 A1
(43) Pub. Date: Aug. 10, 2017

(54) LOW-VOC AMINES AS A SURFACE-ACTIVE COMPONENT IN DISPERSIONS

(71) Applicant: Clariant International Ltd., Muttenz (CH)

(72) Inventors: Rainer KUPFER, Hattersheim (DE); Christoph SÖFFING, Mettmann (DE)

(73) Assignee: Clariant International Ltd., Muttenz (CH)

(21) Appl. No.: 15/502,931

(22) PCT Filed: Jul. 13, 2015
(86) PCT No.: PCT/EP2015/065931

§ 371 Date: Feb. 9, 2017

(30) Foreign Application Priority Data
Aug. 13, 2014 (DE) 102014012020.1

(51) Int. Cl. C09D 5/02; C09D 125/14

(52) U.S. Cl. CPC C09D 5/027; C09D 5/025; C09D 5/028; C09D 125/14

(57) ABSTRACT

The invention relates to a dispersion containing (A) at least one compound of the formula (I), wherein R¹ denotes H, C₁-C₄ alkyl, CH₂CH₂OH or CH₂CH(CH₃)OH, (B) a polymeric binder and (C) water.

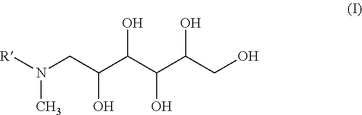

The subject matter of the present invention are low-VOC odorless amines from renewable raw materials as neutralizing and stabilizing agents for aqueous dispersions.

In aqueous emulsion paints, the prior art typically uses ammoniacal solutions or amines such as 2-amino-2-methyl-1-propanol as alkalis. Prominent features of such compounds, however, are their typical amine odor and their VOC content. Given that volatile organic compounds of this kind, together with UV radiation and NOₓ, are conducive to formation of ozone, many countries have passed statutes for reducing the VOC content (e.g., 2004/42/EC). As well as protecting the environment, these statutes also serve to protect the population from adverse health effects due to airborne pollutants.

WO 2013/123153 describes nonionic surfactants having one or more amine functions, and also one or more alkyl chains as hydrophilic part.

The neutralizing capacity of trihydroxy monoamines and trihydroxy diamines in aqueous paints is described in WO 2010/126657 and U.S. 2010/0326320, respectively. Also described are the properties of the resultant paints and coatings with respect to viscosity, hiding power, yellowing, gloss, wet abrasion resistance, and adhesiveness.

Carboxydiamines are described in W02014/003969 and are capable of acting as a low-VOC neutralizing agent in paints, coatings, and cleaning products. Carboxydiamines, however, are obtainable only by multistage syntheses from petrochemical raw materials.

EP 0614881, U.S. Pat. No. 5,449,770 and U.S. Pat. No. 2,016,962 describe techniques for preparing glucamines, starting from glucose.

EP 1676831 provides a general description of the preparation of tertiary dialkylglucamines such as diethylglucamine and of the use thereof as a surfactant in aqueous coatings, but without giving any concrete example.

The object of the present invention was to find amines which are prepared from renewable raw materials and can be used to regulate the pH in order thus to allow the production of aqueous emulsion paints. The amines ought additionally to be VOC-free.

Surprisingly it has been found that this is possible with amines based on glucose as their renewable raw material.

The invention accordingly provides a dispersion comprising

(A) at least one compound of the formula (I)

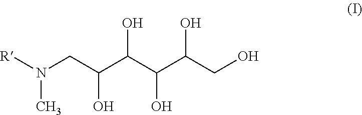

in which R¹ is H, C₁-C₄ alkyl, CH₂CH₂OH or CH₂CH(CH₃)OH,

(B) a polymeric binder, and

(C) water.

The dispersion may further comprise customary constituents of aqueous emulsion paints. Customary constituents may include the following: pigments, with the term “pigments” relating to pigments, and to fillers in the wider sense, and auxiliaries.

Auxiliaries may include wetting agents and dispersants, defoamers, biocides, coalescents, and rheological additives.

Compound (I) is a polyhydroxy-amine where R¹ may be H, C₁-C₄ alkyl, CH₂CH₂OH or CH₂CH(CH₃)OH. Preferably R¹ is H, methyl or CH₂CH₂OH. The polyhydroxy unit is a hexose, preferably the epimer glucose. The process for preparing the alkylglucamine in the formula (I) is well known to the skilled person. For compounds with R=C₁- to C₄-alkyl for example, it takes place in accordance with the technique indicated in EP-A-167683, by reductive alkylation of N-alkylpolyhydroxylamines with aldehydes or ketones in the presence of hydrogen and a transition metal catalyst. Hydroxyethyl- and hydroxypropyl-N-methyl-glucamine may be prepared by reaction of N-methylglucamine with ethylene oxide or propylene oxide, respectively, in aqueous solution. The compounds of the formula (I) may be used as pure substances or as aqueous solutions. Since the tertiary amines, such as dimethylglucamine, hydroxyethyl- and hydroxypropyl-N-methylglucamine are not very susceptible to the formation of nitrosamines, they are preferential for the dispersions of the invention.

The polymeric binders, component (B), are homo- or copolymers of olefinically unsaturated monomers. Examples of preferred olefinically unsaturated monomers are
vinyl monomers, such as carboxylic esters of vinyl alcohol, examples being vinyl acetate, vinyl propionate, vinyl ethers of isononanoic acid or of isodecanoic acid, which are also referred to as C₉ and C₁₀ Versatic acids,
Aryl-substituted olefins, such as styrene and stilbene,
olefinically unsaturated carboxylic esters, such as methyl acrylate, ethyl acrylate and propyl acrylate, n-butyl acrylate, isobutyl acrylate, pentyl acrylate, hexyl acrylate, 2-ethylhexyl acrylate, tridecyl acrylate, stearyl acrylate, hydroxyethyl acrylate, hydroxypropyl acrylate, and also the corresponding methacrylic esters,
olefinically unsaturated dicarboxylic esters, such as dimethyl maleate, diethyl maleate, dipropyl maleate, dibutyl maleate, dipentyl maleate, dihexyl maleate, and di-2-ethylhexyl maleate,
olefinically unsaturated carboxylic acids and dicarboxylic acids, such as acrylic acid, methacrylic acid, itaconic acid, maleic acid, and fumaric acid, and their sodium, potassium, and ammonium salts,
olefinically unsaturated sulfonic acids and phosphonic acids and their alkali metal salts and ammonium salts, such as vinyl sulfonic acid, vinyl phosphonic acid, acrylamidomethylpropane sulfonic acid and their alkali metal salts and ammonium salts, alkyl ammonium salts and hydroxyalkyl ammonium salts, allylsulfonic acid and its alkali metal salts and ammonium salts, acryloyloxethylphosphonic acid and its ammonium salts and alkali metal salts, and also the corresponding methacrylic acid derivatives,
olefinically unsaturated amines, ammonium salts, nitriles, and amides, such as dimethylaminoethyl acrylate, acryloyloxethyltrimethylammonium halides, acrylonitrile, acrylamide, methacrylamide, N-methylacrylamide, N-ethylacrylamide, N-propylacrylamide, N-methylolacrylamide, and also the corresponding methacrylic acid derivatives, and vinylmethylacetamide.

Water, component (C), utilized for preparing the aqueous dispersions of the invention is employed preferably in the form of distilled or deionized water. Drinking water (mains water) and/or water of natural origin may also be used.

Suitable pigments are finely divided, organic or inorganic, white or chromatic pigments or a mixture of different such pigments.

As an exemplary selection of particularly preferred organic pigments, there are carbon black pigments, such as gas blacks or furnace blacks; monoazo and disazo pigments, more particularly the Color Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Yellow 213, Pigment Yellow 214, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and naphthol AS pigments, more particularly the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 254, Pigment Red 256, Pigment Orange 5, Pigment Orange 38 or Pigment Brown 1; laked azo pigments and metal complex pigments, more particularly the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, more particularly the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, more particularly the Colour Index pigments Pigment Yellow 139 or Pigment Yellow 173; phthalocyanine pigments, more particularly the Colour Index pigments Pigment Blue 15, Pigment Blue 15:1, Pigment Blue 15:2, Pigment Blue 15:3, Pigment Blue 15:4, Pigment Blue 15:6, Pigment Blue 16, Pigment Green 7 or Pigment Green 36; anthanthrone, anthroquinone, quinacridone, dioxazine, indanthrone, perylene, perinone, and thioindigo pigments, more particularly the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, more particularly the Colour Index pigments Pigment Red 169, Pigment Blue 56 or Pigment Blue 61.

Examples of suitable inorganic pigments are titanium dioxides, zinc sulfides, zinc oxides, iron oxides, magnetites, manganese iron oxides, chromium oxides, ultramarine, nickel or chromium antimony titanium oxides, manganese titanium rutiles, cobalt oxides, mixed oxides of cobalt and aluminum, rutile mixed-phase pigments, sulfides of the rare earths, spinels of cobalt with nickel and zinc, spinels based on iron and chromium with copper, zinc, and manganese, bismuth vanadates, and also extender pigments; use is made more particularly of the Color

Index pigments Pigment Yellow 184, Pigment Yellow 53, Pigment Yellow 42, Pigment Yellow Brown 24, Pigment Red 101, Pigment Blue 28, Pigment Blue 36, Pigment Green 50, Pigment Green 17, Pigment Black 11, Pigment Black 33, and Pigment White 6; calcium carbonates also referred to as fillers, such as naturally occurring chalk and precipitated calcium carbonate, dolomite, natural silicon dioxide (finely ground quartz), pyrogenic and precipitated silicas, kieselguhr, aluminum oxides, aluminum hydroxides, talc, kaolin, mica (potassium aluminum silicate hydrate), barium sulfates such as naturally occurring heavy spars, and precipitated Blanc Fixe. Preference is also given frequently to using mixtures of inorganic pigments. Mixtures of organic with inorganic pigments are likewise frequently used.

Suitable wetting agents and dispersants are preferably polyacrylate salts, acrylate copolymers and MAA copolymers, alkylphenol ethoxylates and alkylphenol ethoxylate substitutes, such as Guerbet derivatives, fatty acid and fatty alcohol derivatives, more particularly their alcoxylates, and also EO/PO homopolymers and block copolymers, and polysiloxane ethers.

Suitable defoamers are preferably mineral oil defoamers and emulsions thereof, silicone oil defoamers and silicone oil emulsions, polyalkylene glycols, polyalkylene glycol fatty acid esters, fatty acids, higher alcohols, phosphoric esters, hydrophobically modified silica, aluminum tristearate, polyethylene waxes, and amide waxes.

Suitable biocides for preventing the uncontrolled multiplication of bacteria, algae, and fungi are formaldehyde, formaldehyde donor compounds, methylisothiazolinone, chlormethylisothiazolinone, benzisothiazolinone, bronopol, dibromodicyanonebutane, and titanium dioxide coated with silver chloride.

Suitable coalescents are esters and ketones such as benzoates and butyrates, and also ether alcohols and glycols. Particular coalescents include 2,2,4-trimethylpentane-1,3-diol monoisobutyrate, butyl glycol, butyl diglycol, butyl dipropylene glycol, propylene glycol butyl ether, and dipropylene glycol butyl ether.

Suitable rheological additives as agents for regulating the viscosity are, for example, starch derivatives and cellulose derivatives and hydrophobically modified ethoxylated urethane (HEUR) thickeners, alkali-swellable acrylate thickeners, hydrophobically modified acrylate thickeners, polymers of acrylamidomethylpropane sulfonic acid, or fumed silica.

An overview of common auxiliaries is given by Wernfried Heilen et al. in “Additive für wässrige Lacksysteme” [Additives for aqueous paint systems], published by Vincentz Network, 2009.

A further subject of the invention is a method for reducing the phase separation of dispersions between the aqueous phase and the solid phase, familiar to the skilled person as syneresis, by dissolving the compound of the formula (I) and optionally coalescents, defoamers, biocides, rheological additives, and also wetting agents and/or dispersants in water. If pigments are needed, they are dispersed for that purpose under high shear. The resulting composition is subsequently stirred in together with a polymeric binder and optionally with further auxiliaries, at a low shear rate. A dispersing assembly used for this purpose may comprise agitator mechanisms, dissolvers, high-speed mixers or kneading apparatus, preferably a dissolver with sawtooth stirrer. The aforementioned production may take place at temperatures of 0 to 100° C., usefully at 10 to 70° C., preferably at 20 to 40° C.

The compound of the formula (I) is present preferably in a concentration of 0.01% to 10%, more particularly 0.01% to 5.0%, especially 0.01% to 1.0%.

The method can also be utilized, furthermore, to adjust the pH. For that purpose, both at the start and also during the dispersing and formulating operation a sufficient amount of the compound of the formula (I) may be added to the dispersion to give a pH of between 7 and 11.

A particular quality of the dispersion of the invention is the VOC-free and low-odor contribution of the compound of the formula (I) to the overall formulation.

The dispersions of the invention are suitable for producing coatings of all kinds. The dispersions of the invention are especially suitable for producing colored coatings and emulsion paints, dispersion-based varnishes and pressure-sensitive adhesives.

### EXAMPLES

Percentages in this description are percentages by weight, based on the weight of the overall composition, unless indicated otherwise.

### Examples 1-5 (Comparative Examples) and Examples 6-7 in Vinyl Acetate-VeoVa-Acrylate Paint

In this comparative series, ammoniacal solution and the commercial amines diethanolamine (DEA), triethanolamine (TEA), cyclohexydiethanolamine (Genamie®CH-020, Clariant), and 2-amino-2-methyl-1-propanol (AMP-95, Dow) were compared with N-methylglucamine (NMG) and dimethylglucamine (DMG). The compositions of the paints used were as follows, the amines being used equimolarly:

TABLE 1
Composition of the vinyl acetate-VeoVa-acrylate paints in wt %

| | | 1 | 2 | 3 | 4 | 5 | | |
|---|---|---|---|---|---|---|---|---|
| | Component | (C) | (C) | (C) | (C) | (C) | 6 | 7 |
| 1 | Water | 29.0 | 28.9 | 28.9 | 28.8 | 29.0 | 28.8 | 28.5 |
| 2 | NH₃ (25% in water) | 0.1 | | | | | | |
| | DEA | | 0.2 | | | | | |
| | TEA | | | 0.2 | | | | |
| | Genamin ® CH-020 | | | | 0.3 | | | |
| | AMP-95 | | | | | 0.1 | | |
| | NMG | | | | | | 0.3 | |
| | DMG (50% in water) | | | | | | | 0.6 |
| 3 | Calgon ® N (dispersant) | 0.1 | 0.1 | 0.1 | 0.1 | 0.1 | 0.1 | 0.1 |
| 4 | Bermocoll ® EHM 200 (thickener) | 0.5 | 0.5 | 0.5 | 0.5 | 0.5 | 0.5 | 0.5 |
| 5 | Texanol ® (coalescent) | 0.5 | 0.5 | 0.5 | 0.5 | 0.5 | 0.5 | 0.5 |
| 6 | Dowanol ® DPnB (coalescent) | 1.0 | 1.0 | 1.0 | 1.0 | 1.0 | 1.0 | 1.0 |
| 7 | Byk ® 038 (defoamer) | 0.3 | 0.3 | 0.3 | 0.3 | 0.3 | 0.3 | 0.3 |
| 8 | Mowiplus ® XW 330 (wetting agent) | 0.3 | 0.3 | 0.3 | 0.3 | 0.3 | 0.3 | 0.3 |
| 9 | Nipacide ® BMS (biocide) | 0.2 | 0.2 | 0.2 | 0.2 | 0.2 | 0.2 | 0.2 |
| 10 | Finntalc ® M 20 SL (filler) | 8.0 | 8.0 | 8.0 | 8.0 | 8.0 | 8.0 | 8.0 |
| 11 | Mica ® TF (filler) | 8.0 | 8.0 | 8.0 | 8.0 | 8.0 | 8.0 | 8.0 |
| 12 | Omyacarb ® 10 - AV (filler) | 17.0 | 17.0 | 17.0 | 17.0 | 17.0 | 17.0 | 17.0 |
| 13 | Omyacarb ® extra - CL (filler) | 17.0 | 17.0 | 17.0 | 17.0 | 17.0 | 17.0 | 17.0 |
| 14 | Kronos ® 2160 (pigment) | 4.0 | 4.0 | 4.0 | 4.0 | 4.0 | 4.0 | 4.0 |
| 15 | Water | 5.4 | 5.4 | 5.4 | 5.4 | 5.4 | 5.4 | 5.4 |
| 16 | Mowilith ® DM 2452, 50% (binder) | 8.0 | 8.0 | 8.0 | 8.0 | 8.0 | 8.0 | 8.0 |
| 17 | Tafigel ® PU 40 (1:9 in water) | 0.3 | 0.3 | 0.3 | 0.3 | 0.3 | 0.3 | 0.3 |
| | (rheology modifier) | | | | | | | |
| 18 | Agitan ® 282 (defoamer) | 0.3 | 0.3 | 0.3 | 0.3 | 0.3 | 0.3 | 0.3 |
| | Total | 100 | 100 | 100 | 100 | 100 | 100 | 100 |
| | PVC | 84.3 | 84.3 | 84.3 | 84.3 | 84.3 | 84.3 | 84.3 |
| | Solids content | 58.0 | 58.0 | 58.0 | 58.0 | 58.0 | 58.0 | 58.0 |

Components 1-14 were dispersed at room temperature by a successive addition at high shear rate by means of a dissolver from Getzmann with a sawtooth stirrer. Then components 15-18 were stirred in at a low shear rate.

### Examples 8-12 (Comparative Examples) and Examples 13-14 in Styrene-Acrylate Paint

TABLE 2
Composition of the styrene-acrylate paints in wt %

| | | 8 | 9 | 10 | 11 | 12 | | |
|---|---|---|---|---|---|---|---|---|
| | Component | (V) | (V) | (V) | (V) | (V) | 13 | 14 |
| 1 | Water | 25.5 | 25.4 | 25.4 | 25.3 | 25.5 | 25.3 | 24.9 |
| 2 | NH₃ (25% in water) | 0.1 | | | | | | |
| | DEA | | 0.2 | | | | | |
| | TEA | | | 0.2 | | | | |
| | Genamin ® CH-020 | | | | 0.3 | | | |
| | AMP-95 | | | | | 0.1 | | |
| | NMG | | | | | | 0.3 | |
| | DMG (50% in water) | | | | | | | 0.6 |
| 3 | Calgon ® N (dispersant) | 0.1 | 0.1 | 0.1 | 0.1 | 0.1 | 0.1 | 0.1 |
| 4 | Tylose ® MH 10000 (thickener) | 0.5 | 0.5 | 0.5 | 0.5 | 0.5 | 0.5 | 0.5 |
| 5 | Genapol ® ED 3060 (dispersant) | 0.2 | 0.2 | 0.2 | 0.2 | 0.2 | 0.2 | 0.2 |
| 6 | Texanol ® (coalescent) | 1.9 | 1.9 | 1.9 | 1.9 | 1.9 | 1.9 | 1.9 |
| 7 | Byk ® 038 (defoamer) | 0.1 | 0.1 | 0.1 | 0.1 | 0.1 | 0.1 | 0.1 |
| 8 | Mowiplus ® XW 330 (wetting agent) | 0.5 | 0.5 | 0.5 | 0.5 | 0.5 | 0.5 | 0.5 |
| 9 | Nipacide ® BMS (biocide) | 0.2 | 0.2 | 0.2 | 0.2 | 0.2 | 0.2 | 0.2 |
| 12 | Omyacarb ® 2 GU (filler) | 15.0 | 15.0 | 15.0 | 15.0 | 15.0 | 15.0 | 15.0 |
| 14 | Kronos ® 2160 (pigment) | 12.0 | 12.0 | 12.0 | 12.0 | 12.0 | 12.0 | 12.0 |
| 15 | Water | 5.4 | 5.4 | 5.4 | 5.4 | 5.4 | 5.4 | 5.4 |
| 16 | Mowilith ® LDM 7714 (binder) | 38.2 | 38.2 | 38.2 | 38.2 | 38.2 | 38.2 | 38.2 |
| 17 | Tafigel ® PU 40 (1:9 in water) | 0.3 | 0.3 | 0.3 | 0.3 | 0.3 | 0.3 | 0.3 |
| | (rheology modifier) | | | | | | | |
| | Total | 100 | 100 | 100 | 100 | 100 | 100 | 100 |
| | PVC | 32.8 | 32.8 | 32.8 | 32.8 | 32.8 | 32.8 | 32.8 |
| | Solids content | 46.1 | 46.1 | 46.1 | 46.1 | 46.1 | 46.1 | 46.1 |

Components 1-14 were dispersed by successive addition at high shear rate. Then components 15-18 were stirred in at low shear rate.

The paints were assessed for pH, viscosity, freeze-thaw stability, and wet abrasion. To simulate storage stability, the paint was stored at 60° C. for a week, and assessed for syneresis, pH and viscosity. The parameters for this were determined as below.

The pH was determined using a pH electrode from Knick (SE 100N) following the formulation of the paint and after one week at 60° C.

The viscosity was determined on a Haake Viscotester 550 from ThermoScientific.

The wet abrasion resistance was determined in accordance with standards DIN EN ISO 11998 and DIN EN 13300 on a 200 μm paint film after drying at room temperature for one week.

For the determination of the freeze-thaw stability, a sample of a paint was frozen at −18° C. and then thawed again. This process was repeated for as long as no permanent damage was in evidence. An assessment was made of the number of cycles of freeze-thaw stability.

For the determination of the syneresis, the same amount of paint was introduced into a vessel with fill level scaling. The amount of water separated after storage at 60° C. for one week was then read off and documented as a percentage of the amount of paint.

TABLE 3
Results of the performance investigations of examples 1 to 7

| | | | | | | | | | Wet abrasion | | | |
|---|---|---|---|---|---|---|---|---|---|---|---|---|
| | | | Viscosity 1/2 s | | Viscosity 1/60 s | | Viscosity 1/200 s | | Mean loss | | | |
| | pH | | [mPas] | | [mPas] | | [mPas] | | of film | | Cycles of | |
| | | 1 week at | | 1 week at | | 1 week at | | 1 week at | thickness | Abrasion | freeze-thaw | Syneresis |
| Example | Initial | 60° C. | Initial | 60° C. | Initial | 60° C. | Initial | 60° C. | [μm] | class | stability | [%] |
| 1 | 9.4 | 9.1 | 5591 | 6301 | 3017 | 3701 | 1565 | 1774 | 77.2 | 3 | 0 | 5.0 |
| 2 | 9.2 | 8.9 | 5058 | 6505 | 3122 | 2822 | 1617 | 1426 | 65.0 | 3 | 0 | 4.0 |
| 3 | 9.0 | 8.7 | 7128 | 6682 | 3602 | 3339 | 1984 | 1833 | 64.4 | 3 | 0 | 5.0 |
| 4 | 9.3 | 9.1 | 7240 | 10782 | 3122 | 5012 | 1705 | 2676 | 74.7 | 3 | 0 | 6.0 |
| 5 | 9.6 | 9.1 | 7266 | 5606 | 2910 | 3036 | 1516 | 1508 | 80.3 | 3 | 0 | 4.5 |
| 6 | 9.5 | 9.1 | 7615 | 6177 | 2860 | 3008 | 1515 | 1492 | 87.8 | 3 | 0 | 2.5 |
| 7 | 9.3 | 8.9 | 6951 | 5401 | 2872 | 2897 | 1529 | 1473 | 99.5 | 3 | 0 | 1.5 |

TABLE 4
Results of the performance investigations of examples 8 to 14

| | | | | | | | | | Wet abrasion | | | |
|---|---|---|---|---|---|---|---|---|---|---|---|---|
| | | | Viscosity 1/2 s | | Viscosity 1/60 s | | Viscosity 1/200 s | | Mean loss | | | |
| | pH | | [mPas] | | [mPas] | | [mPas] | | of film | | Cycles of | |
| | | 1 week at | | 1 week at | | 1 week at | | 1 week at | thickness | Abrasion | freeze-thaw | Syneresis |
| Example | Initial | 60° C. | Initial | 60° C. | Initial | 60° C. | Initial | 60° C. | [μm] | class | stability | [%] |
| 8 | 8.2 | 8.1 | 10140 | 5606 | 1244 | 973 | 593 | 466 | 11.6 | 2 | 2 | 35 |
| 9 | 8.7 | 8.5 | 11316 | 9825 | 1294 | 893 | 404 | 612 | 10.6 | 2 | 2 | 35 |
| 10 | 8.4 | 8.4 | 10569 | 10654 | 1281 | 1108 | 603 | 494 | 9.0 | 2 | 2 | 35 |
| 11 | 8.5 | 8.4 | 11865 | 8275 | 1287 | 892 | 611 | 434 | 11.5 | 2 | 2 | 30 |
| 12 | 8.7 | 8.5 | 9535 | 6487 | 1202 | 844 | 572 | 416 | 13.4 | 2 | 2 | 30 |
| 13 | 8.7 | 8.5 | 13010 | 8031 | 1399 | 757 | 661 | 360 | 13.9 | 2 | 2 | 20 |
| 14 | 8.6 | 8.4 | 12760 | 6145 | 1397 | 690 | 667 | 337 | 12.2 | 2 | 2 | 18 |

It was found that through the addition of the amines in all cases the paint had a pH of 8 to 10. The results in tables 3 and 4, moreover, show that the paints have a comparable profile of properties in relation to viscosity, wet abrasion, and freeze-thaw stability. As far as the syneresis was concerned, NMG and DMG were observed to reduce significantly the syneresis in comparison to the comparative amines.

The VOC content of the amines was determined in accordance with DIN EN ISO 17895 for 0.1% A to 15% VOC content and in accordance with DIN EN ISO 11890-2 for 0.01% to 0.1% VOC content. The odor of the samples was determined by olfactory means. VOC content and odor of the comparative amines ammonia, monoethanolamine (MEA), DEA, TEA, AMP-95 and Genamin® CH-020, and also of the inventive amines NMG and DMG, are summarized in table 5.

TABLE 5
Odor and VOC content of the amines described

| Amines | VOC [%] | Method | Odor |
|---|---|---|---|
| NH₃ | — | — | Acrid |
| MEA | >15 | DIN 11890-2 | Fishy/acrid |
| DEA | >15 | DIN 11890-2 | Slightly fishy |
| TEA | <0.01 | DIN 17895 | Fishy |
| Genamin ® CH-020 | 3.1 | DIN 11890-2 | Fishy |
| AMP-95 | >15 | DIN 11890-2 | Fishy/acrid |
| NMG | <0.01 | DIN 17895 | Odorless |
| DMG | <0.01 | DIN 17895 | Odorless |

1. A dispersion comprising
(A) at least one compound of the formula (I) 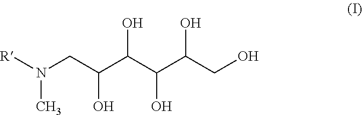
in which R¹ is H, C₁-C₄ alkyl, CH₂CH₂OH or CH₂CH(CH₃)OH,
(B) a polymeric binder which is a homo- or copolymer of olefinically unsaturated monomers, and
(C) water.

2. The dispersion as claimed in claim 1, further comprising one or more of the constituents selected from the group consisting of pigment, dispersant, defoamer, coalescent, rheological additive, biocide, and wetting agent.

3. The dispersion as claimed in claim 1, here R¹ is H, methyl or CH₂CH₂OH.

4. The dispersion as claimed in claim 1, where R¹ is H or methyl.

5. The dispersion as claimed in claim 1, wherein the concentration of the compound of the formula (I) is 0.01 wt % to 10 wt %.

6. The dispersion as claimed in claim 1, wherein the concentration of the compound of the formula (I) is 0.01 wt % to 5 wt %.

7. The dispersion as claimed in claim 1, wherein the concentration of the compound of the formula (I) is 0.01 wt % to 1 wt %.

8. The dispersion as claimed in claim 1, further comprising a white or chromatic pigment in an amount of 10 to 80 wt %.

9. The dispersion as claimed in claim 1, further comprising wetting agents or dispersants in an amount of 0.01 to 10 wt %.

10. The dispersion as claimed in claim 1, further comprising defoamers in an amount of 0.01 to 5 wt %.

11. The dispersion as claimed in claim 1, further comprising biocides in an amount of 0.01 to 5 wt %.

12. The dispersion as claimed in claim 1, further comprising coalescents in an amount of 0 to 5 wt %.

13. The dispersion as claimed in claim 1, further comprising rheological additives in an amount of 0.1 to 10 wt %.

14. The dispersion as claimed in claim 1, comprising 1 to 80 wt % of constituent B).

15. The dispersion as claimed in claim 1, comprising 1 to 80 wt % of water.

16. The dispersion as claimed in claim 1, wherein the compound of the formula (I) is prepared from glucose.

17. (canceled)

18. A method for reducing the separation between an aqueous phase and a solid phase of a dispersion, comprising the step of dissolving a compound of the formula (I) 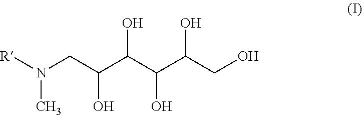
in which R¹ is H, C₁-C₄ alkyl, CH₂CH₂OH or CH₂CH(CH₃)OH and optionally coalescents, defoamers, biocides, rheological additives, wetting agents and/or dispersants in water, and subsequently incorporating a polymeric binder, which is a homo- or copolymer of olefinically unsaturated monomers with stirring at a low shear rate into the dispersion.

19. The method as claimed in claim 18, which takes place at temperatures of 0 to 100° C.

20. (canceled)

21. A method for reducing the separation between an aqueous phase and a solid phase of a dispersion, comprising the step of dissolving a compound of the formula (I) 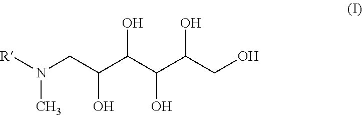
in which R¹ is H, C₁-C₄ alkyl, CH₂CH₂OH or CH₂CH(CH₃)OH and optionally coalescents, defoamers, biocides, rheological additives, wetting agents and/or dispersants in water, and subsequently incorporating a polymeric binder, which is a homo- or copolymer of olefinically unsaturated monomers with stirring at a high shear rate into the dispersion.
